(19) United States
(12) Patent Application Publication
(10) Pub. No.: US 2005/0161952 A1
(43) Pub. Date: Jul. 28, 2005

(54) Connection device, box and clamp

(76) Inventor: Mark Pflanz, Itasca, IL (US)

Correspondence Address: DYKEMA GOSSETT PLLC, FRANKLIN SQUARE, THIRD FLOOR WEST, 1300 I STREET, NW, WASHINGTON, DC, 20005, US

(21) Appl. No.: 10/495,874

(22) PCT Filed: Nov. 7, 2002
(86) PCT No.: PCT/SE02/02040

(30) Foreign Application Priority Data
Nov. 13, 2001 (SE) 0103794-4

(51) Int. Cl. E05C 5/00

(52) U.S. Cl. 292/109

(57) ABSTRACT

From a first aspect, the invention relates to a connection device for a bottom (1) and a lid (3), respectively, to a box that also has side pieces (2). The device comprises one or more first fastening members (5) fixedly connected to the bottom (1) and the lid (3), respectively, and one or more second fastening members (6) fixedly connected to at least one side piece (2). Furthermore, connection members (7) are comprised for connection of the bottom (1) and the lid (3), respectively, to the side piece (2) by interaction with the fastening members (5, 6). Each connection member (7) consists of a clamp having a resilient web (7.1), in one end of which a first hook (7.2) is arranged and in the other end of which a second hook (7, 3) is arranged. The first fastening member consists of a first bar (5) that is arranged along an edge of the bottom (1) and the lid (3), respectively, and which is provided with connection members comprising one or more recesses (5, 4). The second fastening member consists of a second bar (6) that is arranged on a side piece (2) substantially in parallel to the edge of the side piece (2). The first hook (7.2) is arranged to be introduced into a recess (5.4) in the first bar (5). According to the invention, the first bar (5) is provided with a support surface (5.5) situated between the recess (5.4) and the second bar (6) and at a distance from the recess (5.4). The first hook (7.2) of the clamp (7) is provided with a projection (7.5) directed towards the web (7.1) of the clamp. The projection is situated a distance from the first end of the web (7.1), which is at least equal to the distance between the recess (5.4) and the support surface (5.5). Thereby, the clamp (7) cannot fall off from the first bar (5). The invention also relates to a box provided with such a connection device and a clamp (7) intended to be used in such a connection device.

### FIELD OF THE INVENTION

From a first aspect, the present invention relates to a connection device, for a bottom and a lid, respectively, of a box having side pieces comprising one or more first fastening members fixedly connected to the lid and one or more second fastening members fixedly connected to at least one side piece as well as connection members for connection of the lid to the side piece by interaction with the fastening members. Preferably, the bottom, the side pieces as well as the lid are to manufactured from a sheet-type material as, e.g., plywood. From a second aspect, the invention relates to a box provided with a connection device in accordance with the invention and from a third aspect, the invention relates to a clamp intended to constitute a component of the invented connection device.

### PRIOR ART

The Swedish patent specification SE-C-442 823 describes a method for manufacturing a box as well as a device in order to fixedly but detachably connect an edge portion of a first part of the box with an adjacent edge portion of a second part of the box. The Swedish patent specifications SE-A-85 04 578-9 and SE-A-85 04 600-1 describe similar devices for detachable connection of two parts belonging to a box. Similar devices are also disclosed in WO 91/15 404, EP 209 086, FR 1 228 951, and NO 23 235.

Said known devices are impaired by certain disadvantages. These have largely been mastered by means of a connection device described in SE 509 910. Thus, the same describes a connection device for a bottom and a lid, respectively, of a box having side pieces, comprising first fastening members fixedly connected to the bottom and the lid, respectively, and second fastening members fixedly connected to at least one side piece, as well as connection members for connection of the bottom and the lid, respectively, to the side piece. The respective connection member consists of a clamp having a resilient web, in the ends of which a first hook and a second hook are arranged. The first fastening member consists of a first bar that is arranged along an edge of the bottom and the lid, respectively. The second fastening member consists of a second bar that is arranged on a side piece substantially in parallel to the edge thereof. The first hook is arranged to be introduced into a recess of the first bar, which along the length thereof has a number of recesses. Although the device according to the last-mentioned document constitutes a considerable advance in relation to the previously known devices, there is room for further improvements. It has turned out that the device has a disadvantage in that the clamps may fall off from the lid after that it has been released from the rest of the box. Especially when the lid is lifted so that it ends up upside down, the clamps fall off and may be lost.

Further, by WO 01/70588 a device is previously known where said disadvantages are obviated. This is achieved by means of a clamp, which is included in the connection device, being provided with a third hook in addition to a hook at each end. Said third hook prevents the clamp from unintentionally falling off.

Although this construction solves the problem of the fact that the clamp may come loose, there is a need to achieve this in an easier manner.

In the light of this, the object of the present invention is to provide a connection device for a bottom and a lid, respectively, of a box having side pieces where the above-mentioned disadvantage is overcome in a more uncomplicated manner than previously.

### DESCRIPTION OF THE INVENTION

This object has been attained by means of a connection device of the kind defined in the preamble of claim 1 having the special features that are given in the characterizing clause of the claim.

Thus, the first bar is provided with a support surface situated between the recess and the second bar and at a distance from the recess, the first hook of the clamp being provided with a projection directed towards the web of the clamp, which projection is situated at a distance from the first end of the web which is at least equal to the distance between the recess and the support surface.

When the clamp is released from the bars of the side pieces, this arrangement prevents the clamp from falling off by means of the projection hooking on to the support surface in case the lid or bottom is positioned in a manner which otherwise would entail loosening. The arrangement of such a projection on the first hook is a very simple manner to achieve this retention.

According to a preferred embodiment of the invention, the support surface consists of an end edge of the first bar directed towards the second bar. This implies that you for this purpose utilize a part of said bar that normally is part of a connection device of the kind in question and thus does not demand any additional measure.

According to yet a preferred embodiment, the projection consists of an end portion of the first hook, which end portion forms an angle to the rest of the first hook, which angle preferably is substantially 90°. By designing the projection in this manner, the most basic embodiment is achieved and entails no noteworthy additional manufacturing cost. The end portion may be folded in, in one and the same operation in which the two hooks are formed.

According to another preferred embodiment, the end portion is considerably shorter than the rest of the first hook and preferably constitutes 5-20% of the length of the first hook. A short end portion is normally sufficient to attain the desired function of retaining. Furthermore, a short length of the end portion entails that this is not made more difficult when the hook is to be threaded into the recess is of the bar.

The above-mentioned and other advantageous embodiments of the invented connection device are defined in the claims dependent on claim 1.

From a second aspect, the set-up object of the invention is attained by means of a box, as is stated in claim 5, is provided with a connection device according to the invention. This entails advantages of corresponding type as those that have been accounted for above.

From a third aspect of the invention, the set-up object is attained by means of a clamp of the kind stated in the preamble of claim 6 having the special features defined in the characterizing clause of said claim. By the invented clamp, a vital component of the invented connection device is provided.

Advantageous embodiments of the clamp are stated in the claims depending on claim 6. By the invented clamp and the preferred embodiments of the same, advantages of the corresponding type, which has been stated above regarding the invented connection device, are attained.

The invention is closer explained by the subsequent detailed description of preferred embodiments of the same with reference to appended drawing figures.

### BRIEF DESCRIPTION OF THE DRAWINGS

FIG. 1 shows a box seen in a perspective and provided with a connection device according to a first embodiment example of the invention for fastening a lid to the box.

FIG. 2 shows in enlargement a section of the connection device of the box according to FIG. 1.

FIG. 3 separately shows a resilient clamp in perspective included in the connection device of FIG. 4.

FIG. 4 shows a cross-section in enlargement of the connection device on a box like the one in FIG. 1 according to a second embodiment example.

### DESCRIPTION OF EMBODIMENT EXAMPLES

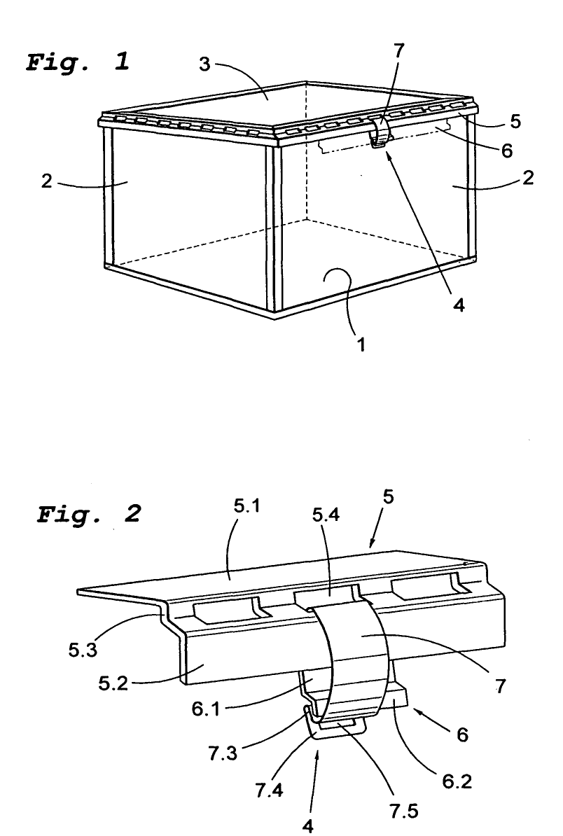

The box shown in FIG. 1 has a bottom 1, four side pieces 2 and a lid 3. The bottom 1, the side pieces 2 as well as the lid 3 are preferably manufactured from laminated board. The lid 3 is resiliently connected to two opposite side pieces 2 by connection devices 4 according to the invention. The box shown in FIG. 1 is provided with two complete connection devices 4 arranged at each side of the box. The bottom 1 of the box may also be resiliently connected to the side pieces 2, but is in the figure only shown schematically connected to the side pieces 2.

The connection device 4 according to the invention comprises a first bar 5, fixedly arranged along two or more of the edges of the lid 3, a second bar 6, fixedly arranged along two or more of the upper edges of the side pieces 2, and at least one clamping member 7 which force-transmittingly connects the first bar 5 with the second bar 6. The first bar 5 has a substantially L-shaped cross-section, the first flange 5.1 of which is fixedly connected to the lid 3 and arranged in the same plane as a plane through the upper plane surface of the lid 3, and the second flange of which extends in a plane parallel to and at a distance from a plane through a plane of the outer plane surface of the corresponding side piece 2. The second flange 5.2 also has a portion 5.3 closest to a first flange 5.1 which is in the same plane as the plane through the outer surface of the side piece 2 and which, when the lid 3 is attached to the box, projects down along the edge of the lid 3. The second bar 6 has a substantially Z-shaped cross-section, one flange 6.1 of which is fixedly connected to the side piece 2 and situated closest to the first bar 5, and the second flange 6.2 of which projects freely down towards the bottom 3 of the box.

The first bar 5 advantageously extends along the entire edge of the lid 3, and preferably along all four edges of the lid 3. The first bar 5 is furthermore provided with recesses 5.4 along the entire length thereof, whereby one or more clamping members 7 may be attached for connection of the lid 3 at the respective side piece 2. The second bar 6 advantageously extends parallelly along the entire first bar 5 and enables an interaction with the first bar 5 by means of one or more clamping members 7 arranged on at least two opposite sides of the box.

In an alternative embodiment of the connection device according to the invention, first bars 5 as well as second bars 6 may be arranged around all four sides of the box and connected to one or more connection members 4 at each side.

At shocks and knocks to the lid 3, e.g. at bumps by lifting forks of a stacker truck, the resilient clamping members 7 enables the lid 3 to move upwards as well as laterally in relation to the side pieces 2 in order to thereupon resume the initial position thereof. In this position, the clamping members 7 exert spring forces that keep the lid 3 pressed against the side pieces 2 of the box. Lateral motions are thereby enabled by a gap being arranged between the outer side of the side piece 2 and the downwardly-directed flange 5.2 of the first bar 5.

The connection device according to the invention may also be utilized at a box that has a lid 3 being articulatedly connected to a side piece 2 by a conventional hinge. The lid 3 cannot in this form be allowed the same movement as in the case where the same is entirely connected to the side pieces 2 by means of the clamping member 7 included in the device. An unrestricted springing is, however, allowed in the case the hinges themselves are resilient and of principally equal embodiment as of the clamping members 7 according to the invention, i.e. has a yoke-shaped web, the ends of which, however, are articulatedly connected to the bottom 1 and lid 2, respectively, of the box.

It is within the scope of the invention to let the bars 5, 6 included in the connection device 4 be substituted by fastening members of different designs and which entirely or partly extend along the edges of the box, but which also may be arranged optionally at the bottom 1, the side pieces 2 or the lid 3. Likewise, the connection member 7 may be composed of a number of parts, at least one part of which is resilient and permits that the bottom 1 and the lid 3, respectively, may move in relation to the side pieces 2.

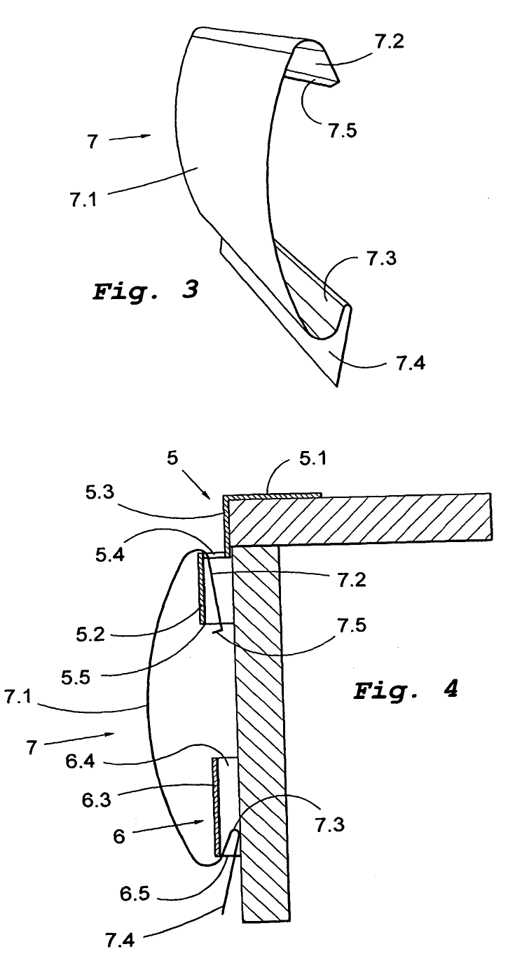

The clamping member 7, which consists of a resilient material such as, e.g., a strip of spring steel, is shown separately in FIG. 3 in a modified embodiment and is shaped as a yoke having a segment-shaped elongated web 7.1 protruding concavely from the box, in one end of which web a first hook 7.2 and second end a second hook 7.3 are arranged. The first hook 7.2 is intended to be hooked on into a recess 5.4 of the first bar 5 of the lid 3 and the second hook is intended to hook on in the free flange 6.2 of the second bar 6 of the side piece 2. With the purpose of facilitating disengagement and removal of the clamping member 7, the second hook 7.3 is provided with a protruding tab 7.4.

The first hook 7.2 is provided with a projection 7.5 by being ended by a short end portion 7.5. The end portion 7.5 is angled inwards in the direction of the web portion 7.1. The end portion 7.5 represents approx. 10% of the entire length of the hook 7.2 and is forming an angle of 90° to the rest of the hook 7.2.

The clamp in FIG. 3 is modified by comparison with the one shown in FIGS. 1 and 2 in that this embodiment is lacking an opening 7.5 in the tab 7.4 that exists in the embodiment according to FIGS. 1 and 2. Such an opening 7.5 may, per se, be applied to the tab 7.4 also in the embodiment according to FIG. 3. In the opening 7.5, a screwdriver or a like tool may be applied for prizing the clamp loose from the side edge by means of pressing the blade of the screwdriver against the web 7.1 which thereby becomes straight and extended so that the hook 7.3 releases the grip thereof of the bar 5.

In FIG. 4 is closer illustrated how a clamp according to the invention interacts with the two fastening members 5 and 6. The clamp 7 is the same clamp as is shown in FIG. 3. The fastening member 5 attached to the lid is of the same type as is shown in FIGS. 1 and 2. The fastening member 6 attached to the side piece 3 is somewhat modified in comparison with the one shown in FIGS. 1 and 2. In the embodiment according to FIG. 4, the fastening member consists of a border 6.3 that extends along the side edge of the box, i.e. perpendicularly to the plane of the figure. The border 6.3 is kept at a distance from the outer side of the side piece 2 by means of retaining struts 6.4 which may be arranged one at each end of the border 6.3 and possibly some between them. Thereby, the border 6.3 forms a gap between itself and the side piece 2, which gap is open at least downwards by the elongated opening of the gap 6.5.

At connection of the lid 3 to a side piece 2, the first hook 7.2 is initially hooked to the clamp 7 in a recess 5.4 of the first bar 5. Then the web 7.1 of the clamp is pressed inwards towards the side piece 2, which results in the lower end thereof being displaced downwards sufficiently for the upper edge of the second hook 7.3 getting below the border 6.3. When the clamping force on the web 7.1 of the clamp subsequently is unloaded, the second hook 7.3 hooks on inbehind the border 6.3. Thereby the lid 3 is attached to the side piece. On disengaging the clamp 7 of the fastening member 6, it is proceeded in the opposite way. The clamp disengaged from the fastening member 6 may advantageously be left hanging on to the fastening member 5 of the lid since there is no risk that it can fall off from the same, such as has been described above. At reclosure of a box where the clamp 7 hangs on to the lid 3, naturally the initial measures are eliminated described above in this paragraph.

The second hook 7.2 has a length downwards to the end portion 7.5 which is equally large as or somewhat larger than the distance from the recess 5.4 down to the lower end edge 5.5 of the bar 5. When the clamp 7 is released from the bar 6 and the lid incidentally is turned upside down, the clamp is prevented from coming loose of the bar 5 by means of the face that the end portion 7.5 then will protrude below the lower edge 5.5 of the bar 5. Thereby, the lower edge 5.5 constitutes a support surface for the end portion 7.5, which prevents the hook 7.2 in this state from moving out of the recess 5.4.

The second fastening member 6 shown in FIG. 4 may of course be designed in the corresponding manner as in the example shown in FIGS. 1 and 2.

1. Connection device for a bottom (1) and a lid (3), respectively, of a box which also has side pieces (2), comprising one or more first fastening members (5) fixedly connected to the bottom (1) and the lid (3), respectively, and one or more second fastening members (6) fixedly connected to at least one side piece (2) as well as connection members (7) for connection of the bottom (1) and the lid (3), respectively, to the side piece (2) by interaction with the fastening members (5, 6), the respective connection member (7) consisting of a clamp having a resilient web (7.1), in one end of which a first hook (7.2) is consisting to a clamp having resilient web (7.1), in one end of which a first hook (7.2) is arranged and in the other end of which a second hook (7.3) is arranged, the first fastening member consisting of a first bar (5), which is arranged along an edge at the bottom (1) and the lid (3), respectively, and which is provided with connection members comprising one or more recesses (5.4) and that the second fastening member consists of a second bar 6) which is arranged on a side piece (2) substantially in parallel to the edge of the side-piece (2), the first hook (7.2) being arranged to be introduced into a recess (5.4) in the first bar (5), characterized in that the first bar (5) is provided with a support surface (5.5) situated between the recess (5.4) and the second bar (6) and at a distance from the recess (5.4) and that the first hook (7.2) of the clamp (7) is provided with a projection (7.5) directed towards the web (7.1) of the clamp, which projection (7.5) is situated at a distance from the first end of the web (7.1) which is at least equally as large as the distance between the recess (5.4) and the support surface (5.5).

2. Connection device according to claim 1, characterized in that the support surface (5.5) consists of an end edge (5.5) of the first bar (5) directed towards the second bar (6).

3. Connection device according to claim 1, characterized in that the projection (7.5) consists of an end portion (7.5) of the first hook (7.2), which end portion (7.5) forms an angle to the rest of the first hook (7.2), which angle preferably is substantially 90°.

4. Connection device according to claim 3, characterized in that the end portion (7.5) is considerably shorter than the rest of the first hook (7.2) and preferably constitutes 5-20% of the length of the first hook (7.2).

5. Box characterized in that it is provided with at least one connection device (4) according to claim 1.

6. Clamp (7) intended for use at a connection device according to claim 1 and which comprises a resilient web (7.1) in one end of which a first hook (7.2) is arranged and in the other end of which a second hook (7.3) is arranged, characterized in that the first hook (7.2) is provided with a projection (5.5) directed towards the web of the clamp.

7. Clamp (7) according to claim 6, characterized in that the projection (7.5) consists of an end portion (7.5) of the first hook (7.2), which end portion (7.5) forms an angle to the rest of the first hook (7.2), which angle preferably is substantially 90°.

8. Clamp (7) according to claim 7, characterized in that the end portion (7.5) is considerably shorter than the rest of the first hook (7.2) and preferably constitutes 5-20% of the length of the first hook.
